(19) United States
(12) Patent Application Publication
(10) Pub. No.: US 2003/0021732 A1
(43) Pub. Date: Jan. 30, 2003

(54) Apparatus for analyzing target materials and methods for fabricating an apparatus for analyzing target materials

(75) Inventors: Aroon V. Tungare, Winfield, IL (US); George T. Valliath, Buffalo Grove, IL (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MOTOROLA, INC., Schaumburg, IL

(21) Appl. No.: 09/911,493

(22) Filed: Jul. 25, 2001

(51) Int. Cl. G01N 21/63

(52) U.S. Cl. 422/82.05; 422/68.1; 422/82.08; 422/82.09; 436/164; 436/165; 436/172; 438/16; 356/300; 356/317; 356/318

(57) ABSTRACT

High quality epitaxial layers of monocrystalline materials can be grown overlying monocrystalline substrates such as large silicon wafers by forming a compliant substrate for growing the monocrystalline layers. One way to achieve the formation of a compliant substrate includes first growing an accommodating buffer layer on a silicon wafer. The accommodating buffer layer is a layer of monocrystalline oxide spaced apart from the silicon wafer by an amorphous interface layer of silicon oxide. The amorphous interface layer dissipates strain and permits the growth of a high quality monocrystalline oxide accommodating buffer layer. The accommodating buffer layer is lattice matched to both the underlying silicon wafer and the overlying monocrystalline material layer. Any lattice mismatch between the accommodating buffer layer and the underlying silicon substrate is taken care of by the amorphous interface layer. In addition, formation of a compliant substrate may include utilizing surfactant enhanced epitaxy, epitaxial growth of single crystal silicon onto single crystal oxide, and epitaxial growth of Zintl phase materials. The foregoing is used in an apparatus and method for analyzing target materials.

### FIELD OF THE INVENTION

This invention relates generally to semiconductor structures and devices and to a method for their fabrication, and more specifically to semiconductor structures and devices and to the fabrication and use of semiconductor structures, devices, and integrated circuits that include a monocrystalline material layer comprised of semiconductor material, compound semiconductor material, and/or other types of material such as metals and non-metals, and even more specifically to an apparatus structure and method for analyzing target materials that includes a monocrystalline material layer comprised of semiconductor material, compound semiconductor material, and/or other types of material such as metals and non-metals.

### BACKGROUND OF THE INVENTION

Semiconductor devices often include multiple layers of conductive, insulating, and semiconductive layers. Often, the desirable properties of such layers improve with the crystallinity of the layer. For example, the electron mobility and band gap of semiconductive layers improves as the crystallinity of the layer increases. Similarly, the free electron concentration of conductive layers and the electron charge displacement and electron energy recoverability of insulative or dielectric films improves as the crystallinity of these layers increases.

For many years, attempts have been made to grow various monolithic thin films on a foreign substrate such as silicon (Si). To achieve optimal characteristics of the various monolithic layers, however, a monocrystalline film of high crystalline quality is desired. Attempts have been made, for example, to grow various monocrystalline layers on a substrate such as germanium, silicon, and various insulators. These attempts have generally been unsuccessful because lattice mismatches between the host crystal and the grown crystal have caused the resulting layer of monocrystalline material to be of low crystalline quality.

If a large area thin film of high quality monocrystalline material was available at low cost, a variety of semiconductor devices could advantageously be fabricated in or using that film at a low cost compared to the cost of fabricating such devices beginning with a bulk wafer of semiconductor material or in an epitaxial film of such material on a bulk wafer of semiconductor material. In addition, if a thin film of high quality monocrystalline material could be realized beginning with a bulk wafer such as a silicon wafer, an integrated device structure could be achieved that took advantage of the best properties of both the silicon and the high quality monocrystalline material. Furthermore, if a thin film of high quality monocrystalline material could be realized beginning with a bulk wafer such as a silicon wafer, an apparatus and method for analyzing target materials could be achieved that took advantage of the best properties of both the silicon and the high quality monocrystalline material.

Accordingly, a need exists for a semiconductor structure that provides a high quality monocrystalline film or layer over another monocrystalline material and for a process for making such a structure that can be utilized in the formation of a multiplexing apparatus of optical lasers. In other words, there is a need for providing the formation of a monocrystalline substrate that is compliant with a high quality monocrystalline material layer so that true two-dimensional growth can be achieved for the formation of quality semiconductor structures, devices and integrated circuits having grown monocrystalline film having the same crystal orientation as an underlying substrate that can be utilized in an apparatus and method for analyzing target materials. This monocrystalline material layer may be comprised of a semiconductor material, a compound semiconductor material, and other types of material such as metals and non-metals.

### BRIEF DESCRIPTION OF THE DRAWINGS

The present invention is illustrated by way of example and not limitation in the accompanying figures, in which like references indicate similar elements, and in which:

FIGS. 1, 2, and 3 illustrate schematically, in cross section, device structures in accordance with various embodiments of the invention;

FIG. 4 illustrates graphically the relationship between maximum attainable film thickness and lattice mismatch between a host crystal and a grown crystalline overlayer;

FIG. 5 illustrates a high resolution Transmission Electron Micrograph of a structure including a monocrystalline accommodating buffer layer;

FIG. 6 illustrates an x-ray diffraction spectrum of a structure including a monocrystalline accommodating buffer layer;

FIG. 7 illustrates a high resolution Transmission Electron Micrograph of a structure including an amorphous oxide layer;

FIG. 8 illustrates an x-ray diffraction spectrum of a structure including an amorphous oxide layer;

FIGS. 9-12 illustrate schematically, in cross-section, the formation of a device structure in accordance with another embodiment of the invention;

FIGS. 13-16 illustrate a probable molecular bonding structure of the device structures illustrated in FIGS. 9-12;

FIGS. 17-20 illustrate schematically, in cross-section, the formation of a device structure in accordance with still another embodiment of the invention;

FIGS. 21-23 illustrate schematically, in cross-section, the formation of yet another embodiment of a device structure in accordance with the invention;

FIG. 24 illustrates schematically, in cross-section the apparatus for analyzing target materials in accordance with the present invention;

FIG. 25 illustrates an assay array configuration for the apparatus of FIG. 24 in accordance with the present invention;

FIG. 26 illustrates a semiconductor structure utilized to at least partially form the semiconductor lasers of FIG. 24 in accordance with the present invention; and

FIG. 27 illustrates schematically, in cross section, a semiconductor structure that can be used to at least partially form the detectors of FIG. 24 in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

FIG. 1 illustrates schematically, in cross section, a portion of a semiconductor structure 20 in accordance with an embodiment of the invention. Semiconductor structure 20 includes a monocrystalline substrate 22, accommodating buffer layer 24 comprising a monocrystalline material, and a monocrystalline material layer 26. In this context, the term “monocrystalline” shall have the meaning commonly used within the semiconductor industry. The term shall refer to materials that are a single crystal or that are substantially a single crystal and shall include those materials having a relatively small number of defects such as dislocations and the like as are commonly found in substrates of silicon or germanium or mixtures of silicon and germanium and epitaxial layers of such materials commonly found in the semiconductor industry.

In accordance with one embodiment of the invention, structure 20 also includes an amorphous intermediate layer 28 positioned between substrate 22 and accommodating buffer layer 24. Structure 20 may also include a template layer 30 between the accommodating buffer layer and monocrystalline material layer 26. As will be explained more fully below, the template layer helps to initiate the growth of the monocrystalline material layer on the accommodating buffer layer. The amorphous intermediate layer helps to relieve the strain in the accommodating buffer layer and by doing so, aids in the growth of a high crystalline quality accommodating buffer layer.

Substrate 22, in accordance with an embodiment of the invention, is a monocrystalline semiconductor or compound semiconductor wafer, preferably of large diameter. The wafer can be of, for example, a material from Group IV of the periodic table. Examples of Group IV semiconductor materials include silicon, germanium, mixed silicon and germanium, mixed silicon and carbon, mixed silicon, germanium and carbon, and the like. Preferably substrate 22 is a wafer containing silicon or germanium, and most preferably is a high quality monocrystalline silicon wafer as used in the semiconductor industry. Accommodating buffer layer 24 is preferably a monocrystalline oxide or nitride material epitaxially grown on the underlying substrate. In accordance with one embodiment of the invention, amorphous intermediate layer 28 is grown on substrate 22 at the interface between substrate 22 and the growing accommodating buffer layer by the oxidation of substrate 22 during the growth of layer 24. The amorphous intermediate layer serves to relieve strain that might otherwise occur in the monocrystalline accommodating buffer layer as a result of differences in the lattice constants of the substrate and the buffer layer. As used herein, lattice constant refers to the distance between atoms of a cell measured in the plane of the surface. If such strain is not relieved by the amorphous intermediate layer, the strain may cause defects in the crystalline structure of the accommodating buffer layer. Defects in the crystalline structure of the accommodating buffer layer, in turn, would make it difficult to achieve a high quality crystalline structure in monocrystalline material layer 26 which may comprise a semiconductor material, a compound semiconductor material, or another type of material such as a metal or a non-metal.

Accommodating buffer layer 24 is preferably a monocrystalline oxide or nitride material selected for its crystalline compatibility with the underlying substrate and with the overlying material layer. For example, the material could be an oxide or nitride having a lattice structure closely matched to the substrate and to the subsequently applied monocrystalline material layer. Materials that are suitable for the accommodating buffer layer include metal oxides such as the alkaline earth metal titanates, alkaline earth metal zirconates, alkaline earth metal hafnates, alkaline earth metal tantalates, alkaline earth metal ruthenates, alkaline earth metal niobates, alkaline earth metal vanadates, alkaline earth metal tin-based perovskites, lanthanum aluminate, lanthanum scandium oxide, and gadolinium oxide. Additionally, various nitrides such as gallium nitride, aluminum nitride, and boron nitride may also be used for the accommodating buffer layer. Most of these materials are insulators, although strontium ruthenate, for example, is a conductor. Generally, these materials are metal oxides or metal nitrides, and more particularly, these metal oxide or nitrides typically include at least two different metallic elements. In some specific applications, the metal oxides or nitrides may include three or more different metallic elements.

Amorphous interface layer 28 is preferably an oxide formed by the oxidation of the surface of substrate 22, and more preferably is composed of a silicon oxide. The thickness of layer 28 is sufficient to relieve strain attributed to mismatches between the lattice constants of substrate 22 and accommodating buffer layer 24. Typically, layer 28 has a thickness in the range of approximately 0.5-5 nm.

The material for monocrystalline material layer 26 can be selected, as desired, for a particular structure or application. For example, the monocrystalline material of layer 26 may comprise a compound semiconductor which can be selected, as needed for a particular semiconductor structure, from any of the Group IIIA and VA elements (IIIV semiconductor compounds), mixed III-V compounds, Group II(A or B) and VIA elements (II-VI semiconductor compounds), and mixed II-VI compounds. Examples include gallium arsenide (GaAs), gallium indium arsenide (GaInAs), gallium aluminum arsenide (GaAlAs), indium phosphide (InP), cadmium sulfide (CdS), cadmium mercury telluride (CdHgTe), zinc selenide (ZnSe), zinc sulfur selenide (ZnSSe), and the like. However, monocrystalline material layer 26 may also comprise other semiconductor materials, metals, or non-metal materials, which are used in the formation of semiconductor structures, devices and/or integrated circuits.

Appropriate materials for template 30 are discussed below. Suitable template materials chemically bond to the surface of the accommodating buffer layer 24 at selected sites and provide sites for the nucleation of the epitaxial growth of monocrystalline material layer 26. When used, template layer 30 has a thickness ranging from about 1 to about 10 monolayers.

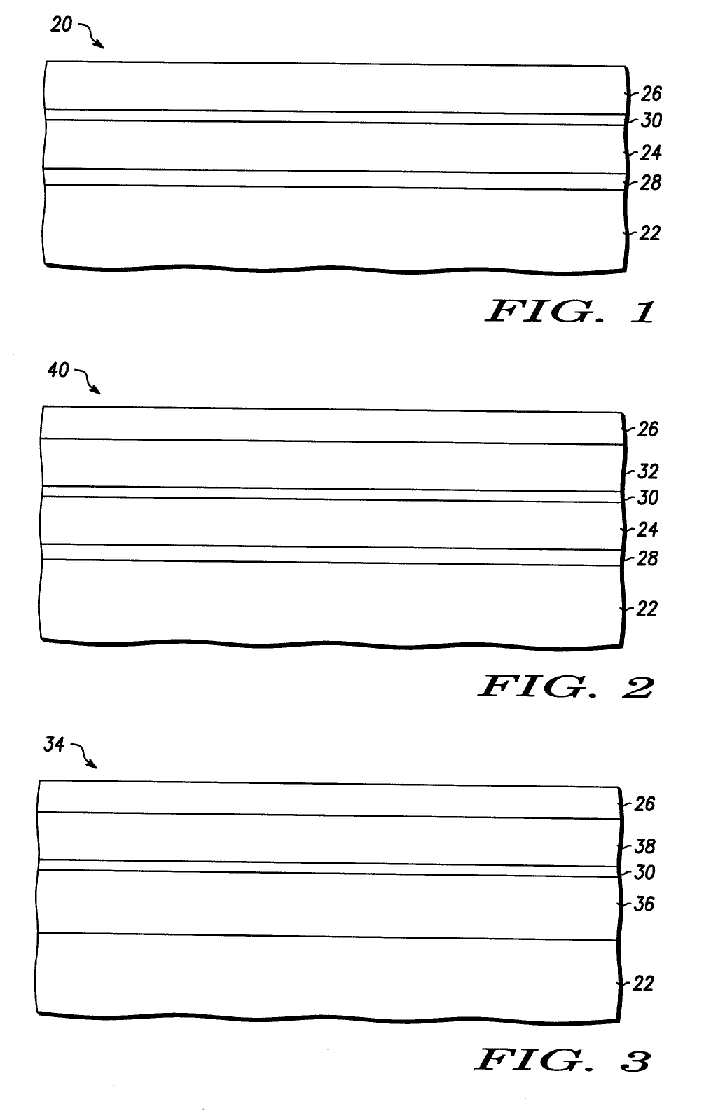

FIG. 2 illustrates, in cross section, a portion of a semiconductor structure 40 in accordance with a further embodiment of the invention. Structure 40 is similar to the previously described semiconductor structure 20, except that an additional buffer layer 32 is positioned between accommodating buffer layer 24 and monocrystalline material layer 26. Specifically, the additional buffer layer is positioned between template layer 30 and the overlying layer of monocrystalline material. The additional buffer layer, formed of a semiconductor or compound semiconductor material when the monocrystalline material layer 26 comprises a semiconductor or compound semiconductor material, serves to provide a lattice compensation when the lattice constant of the accommodating buffer layer cannot be adequately matched to the overlying monocrystalline semiconductor or compound semiconductor material layer.

FIG. 3 schematically illustrates, in cross section, a portion of a semiconductor structure 34 in accordance with another exemplary embodiment of the invention. Structure 34 is similar to structure 20, except that structure 34 includes an amorphous layer 36, rather than accommodating buffer layer 24 and amorphous interface layer 28, and an additional monocrystalline layer 38.

As explained in greater detail below, amorphous layer 36 may be formed by first forming an accommodating buffer layer and an amorphous interface layer in a similar manner to that described above. Monocrystalline layer 38 is then formed (by epitaxial growth) overlying the monocrystalline accommodating buffer layer. The accommodating buffer layer is then exposed to an anneal process to convert the monocrystalline accommodating buffer layer to an amorphous layer. Amorphous layer 36 formed in this manner comprises materials from both the accommodating buffer and interface layers, which amorphous layers may or may not amalgamate. Thus, layer 36 may comprise one or two amorphous layers. Formation of amorphous layer 36 between substrate 22 and additional monocrystalline layer 26 (subsequent to layer 38 formation) relieves stresses between layers 22 and 38 and provides a true compliant substrate for subsequent processing—e.g., monocrystalline material layer 26 formation.

The processes previously described above in connection with FIGS. 1 and 2 are adequate for growing monocrystalline material layers over a monocrystalline substrate. However, the process described in connection with FIG. 3, which includes transforming a monocrystalline accommodating buffer layer to an amorphous oxide layer, may be better for growing monocrystalline material layers because it allows any strain in layer 26 to relax.

Additional monocrystalline layer 38 may include any of the materials described throughout this application in connection with either of monocrystalline material layer 26 or additional buffer layer 32. For example, when monocrystalline material layer 26 comprises a semiconductor or compound semiconductor material, layer 38 may include monocrystalline Group IV or monocrystalline compound semiconductor materials.

In accordance with one embodiment of the present invention, additional monocrystalline layer 38 serves as an anneal cap during layer 36 formation and as a template for subsequent monocrystalline layer 26 formation. Accordingly, layer 38 is preferably thick enough to provide a suitable template for layer 26 growth (at least one monolayer) and thin enough to allow layer 38 to form as a substantially defect free monocrystalline material.

In accordance with another embodiment of the invention, additional monocrystalline layer 38 comprises monocrystalline material (e.g., a material discussed above in connection with monocrystalline layer 26) that is thick enough to form devices within layer 38. In this case, a semiconductor structure in accordance with the present invention does not include monocrystalline material layer 26. In other words, the semiconductor structure in accordance with this embodiment only includes one monocrystalline layer disposed above amorphous oxide layer 36.

The following non-limiting, illustrative examples illustrate various combinations of materials useful in structures 20, 40, and 34 in accordance with various alternative embodiments of the invention. These examples are merely illustrative, and it is not intended that the invention be limited to these illustrative examples.

### EXAMPLE 1

In accordance with one embodiment of the invention, monocrystalline substrate 22 is a silicon substrate oriented in the (100) direction. The silicon substrate can be, for example, a silicon substrate as is commonly used in making complementary metal oxide semiconductor (CMOS) integrated circuits having a diameter of about 200-300 mm. In accordance with this embodiment of the invention, accommodating buffer layer 24 is a monocrystalline layer of Sr_{z}Ba_{1-z}TiO₃ where z ranges from 0 to 1 and the amorphous intermediate layer is a layer of silicon oxide (SiOₓ) formed at the interface between the silicon substrate and the accommodating buffer layer. The value of z is selected to obtain one or more lattice constants closely matched to corresponding lattice constants of the subsequently formed layer 26. The accommodating buffer layer can have a thickness of about 2 to about 100 nanometers (nm) and preferably has a thickness of about 5 nm. In general, it is desired to have an accommodating buffer layer thick enough to isolate the monocrystalline material layer 26 from the substrate to obtain the desired electrical and optical properties. Layers thicker than 100 nm usually provide little additional benefit while increasing cost unnecessarily; however, thicker layers may be fabricated if needed. The amorphous intermediate layer of silicon oxide can have a thickness of about 0.5-5 nm, and preferably a thickness of about 1 to 2 nm.

In accordance with this embodiment of the invention, monocrystalline material layer 26 is a compound semiconductor layer of gallium arsenide (GaAs) or aluminum gallium arsenide (AlGaAs) having a thickness of about 1 nm to about 100 micrometers (μm) and preferably a thickness of about 0.5 μm to 10 μm. The thickness generally depends on the application for which the layer is being prepared. To facilitate the epitaxial growth of the gallium arsenide or aluminum gallium arsenide on the monocrystalline oxide, a template layer is formed by capping the oxide layer. The template layer is preferably 1-10 monolayers of Ti—As, Sr—O—As, Sr—Ga—O, or Sr—Al—O. By way of a preferred example, 1-2 monolayers of Ti—As or Sr—Ga—O have been illustrated to successfully grow GaAs layers.

### EXAMPLE 2

In accordance with a further embodiment of the invention, monocrystalline substrate 22 is a silicon substrate as described above. The accommodating buffer layer is a monocrystalline oxide of strontium or barium zirconate or hafnate in a cubic or orthorhombic phase with an amorphous intermediate layer of silicon oxide formed at the interface between the silicon substrate and the accommodating buffer layer. The accommodating buffer layer can have a thickness of about 2-100 nm and preferably has a thickness of at least 5 nm to ensure adequate crystalline and surface quality and is formed of a monocrystalline SrZrO₃, BaZrO₃, SrHfO₃, BaSnO₃ or BaHfO₃. For example, a monocrystalline oxide layer of BaZrO₃ can grow at a temperature of about 700 degrees C. The lattice structure of the resulting crystalline oxide exhibits a 45-degree rotation with respect to the substrate silicon lattice structure.

An accommodating buffer layer formed of these zirconate or hafnate materials is suitable for the growth of a monocrystalline material layer, which comprises compound semiconductor materials in the indium phosphide (InP) system. In this system, the compound semiconductor material can be, for example, indium phosphide (InP), indium gallium arsenide (InGaAs), aluminum indium arsenide, (AlInAs), or aluminum gallium indium arsenic phosphide (AlGaInAsP), having a thickness of about 1.0 nm to 10 μm. A suitable template for this structure is 1-10 monolayers of zirconium-arsenic (Zr—As), zirconium-phosphorus (Zr—P), hafnium-arsenic (Hf—As), hafnium-phosphorus (Hf—P), strontium-oxygen-arsenic (Sr—O—As), strontium-oxygen-phosphorus (Sr—O—P), barium-oxygen-arsenic (Ba—O—As), indium-strontium-oxygen (In—Sr—O), or barium-oxygen-phosphorus (Ba—O—P), and preferably 1-2 monolayers of one of these materials. By way of an example, for a barium zirconate accommodating buffer layer, the surface is terminated with 1-2 monolayers of zirconium followed by deposition of 1-2 monolayers of arsenic to form a Zr—As template. A monocrystalline layer of the compound semiconductor material from the indium phosphide system is then grown on the template layer. The resulting lattice structure of the compound semiconductor material exhibits a 45 degree rotation with respect to the accommodating buffer layer lattice structure and a lattice mismatch to (100) InP of less than 2.5%, and preferably less than about 1.0%.

### EXAMPLE 3

In accordance with a further embodiment of the invention, a structure is provided that is suitable for the growth of an epitaxial film of a monocrystalline material comprising a II-VI material overlying a silicon substrate. The substrate is preferably a silicon wafer as described above. A suitable accommodating buffer layer material is SrₓBa₁₋ₓTiO₃, where x ranges from 0 to 1, having a thickness of about 2-100 nm and preferably a thickness of about 5-15 nm. Where the monocrystalline layer comprises a compound semiconductor material, the II-VI compound semiconductor material can be, for example, zinc selenide (ZnSe) or zinc sulfur selenide (ZnSSe). A suitable template for this material system includes 1-10 monolayers of zinc-oxygen (Zn—O) followed by 1-2 monolayers of an excess of zinc followed by the selenidation of zinc on the surface. Alternatively, a template can be, for example, 1-10 monolayers of strontium-sulfur (Sr—S) followed by the ZnSeS.

### EXAMPLE 4

This embodiment of the invention is an example of structure 40 illustrated in FIG. 2. Substrate 22, accommodating buffer layer 24, and monocrystalline material layer 26 can be similar to those described in example 1. In addition, an additional buffer layer 32 serves to alleviate any strains that might result from a mismatch of the crystal lattice of the accommodating buffer layer and the lattice of the monocrystalline material. Buffer layer 32 can be a layer of germanium or a GaAs, an aluminum gallium arsenide (AlGaAs), an indium gallium phosphide (InGaP), an aluminum gallium phosphide (AlGaP), an indium gallium arsenide (InGaAs), an aluminum indium phosphide (AlInP), a gallium arsenide phosphide (GaAsP), or an indium gallium phosphide (InGaP) strain compensated superlattice. In accordance with one aspect of this embodiment, buffer layer 32 includes a GaAsₓPₗ₋ₓ superlattice, wherein the value of x ranges from 0 to 1. In accordance with another aspect, buffer layer 32 includes an In_{y}Ga_{l-y}P superlattice, wherein the value of y ranges from 0 to 1. By varying the value of x or y, as the case may be, the lattice constant is varied from bottom to top across the superlattice to create a match between lattice constants of the underlying oxide and the overlying monocrystalline material which in this example is a compound semiconductor material. The compositions of other compound semiconductor materials, such as those listed above, may also be similarly varied to manipulate the lattice constant of layer 32 in a like manner. The superlattice can have a thickness of about 50-500 nm and preferably has a thickness of about 100-200 nm. The template for this structure can be the same of that described in example 1. Alternatively, buffer layer 32 can be a layer of monocrystalline germanium having a thickness of 1-50 nm and preferably having a thickness of about 2-20 nm. In using a germanium buffer layer, a template layer of either germanium-strontium (Ge—Sr) or germanium-titanium (Ge—Ti) having a thickness of about one monolayer can be used as a nucleating site for the subsequent growth of the monocrystalline material layer which in this example is a compound semiconductor material. The formation of the oxide layer is capped with either a monolayer of strontium or a monolayer of titanium to act as a nucleating site for the subsequent deposition of the monocrystalline germanium. The monolayer of strontium or titanium provides a nucleating site to which the first monolayer of germanium can bond.

### EXAMPLE 5

This example also illustrates materials useful in a structure 40 as illustrated in FIG. 2. Substrate material 22, accommodating buffer layer 24, monocrystalline material layer 26 and template layer 30 can be the same as those described above in example 2. In addition, additional buffer layer 32 is inserted between the accommodating buffer layer and the overlying monocrystalline material layer. The buffer layer, a further monocrystalline material that in this instance comprises a semiconductor material, can be, for example, a graded layer of indium gallium arsenide (InGaAs) or indium aluminum arsenide (InAlAs). In accordance with one aspect of this embodiment, additional buffer layer 32 includes InGaAs, in which the indium composition varies from 0 to about 50%. The additional buffer layer 32 preferably has a thickness of about 10-30 nm. Varying the composition of the buffer layer from GaAs to InGaAs serves to provide a lattice match between the underlying monocrystalline oxide material and the overlying layer of monocrystalline material, which in this example is a compound semiconductor material. Such a buffer layer is especially advantageous if there is a lattice mismatch between accommodating buffer layer 24 and monocrystalline material layer 26.

### EXAMPLE 6

This example provides exemplary materials useful in structure 34, as illustrated in FIG. 3. Substrate material 22, template layer 30, and monocrystalline material layer 26 may be the same as those described above in connection with example 1.

Amorphous layer 36 is an amorphous oxide layer, which is suitably formed of a combination of amorphous intermediate layer materials (e.g., layer 28 materials as described above) and accommodating buffer layer materials (e.g., layer 24 materials as described above). For example, amorphous layer 36 may include a combination of SiOₓ and Sr_{z}Ba_{1-z}TiO₃ (where z ranges from 0 to 1),which combine or mix, at least partially, during an anneal process to form amorphous oxide layer 36.

The thickness of amorphous layer 36 may vary from application to application and may depend on such factors as desired insulating properties of layer 36, type of monocrystalline material comprising layer 26, and the like. In accordance with one exemplary aspect of the present embodiment, layer 36 thickness is about 2 nm to about 100 nm, preferably about 2-10 nm, and more preferably about 5-6 nm.

Layer 38 comprises a monocrystalline material that can be grown epitaxially over a monocrystalline oxide material such as material used to form accommodating buffer layer 24. In accordance with one embodiment of the invention, layer 38 includes the same materials as those comprising layer 26. For example, if layer 26 includes GaAs, layer 38 also includes GaAs. However, in accordance with other embodiments of the present invention, layer 38 may include materials different from those used to form layer 26. In accordance with one exemplary embodiment of the invention, layer 38 is about 1 monolayer to about 100 nm thick.

Referring again to FIGS. 1-3, substrate 22 is a monocrystalline substrate such as a monocrystalline silicon or gallium arsenide substrate. The crystalline structure of the monocrystalline substrate is characterized by a lattice constant and by a lattice orientation. In similar manner, accommodating buffer layer 24 is also a monocrystalline material and the lattice of that monocrystalline material is characterized by a lattice constant and a crystal orientation. The lattice constants of the accommodating buffer layer and the monocrystalline substrate must be closely matched or, alternatively, must be such that upon rotation of one crystal orientation with respect to the other crystal orientation, a substantial match in lattice constants is achieved. In this context the terms “substantially equal” and “substantially matched” mean that there is sufficient similarity between the lattice constants to permit the growth of a high quality crystalline layer on the underlying layer.

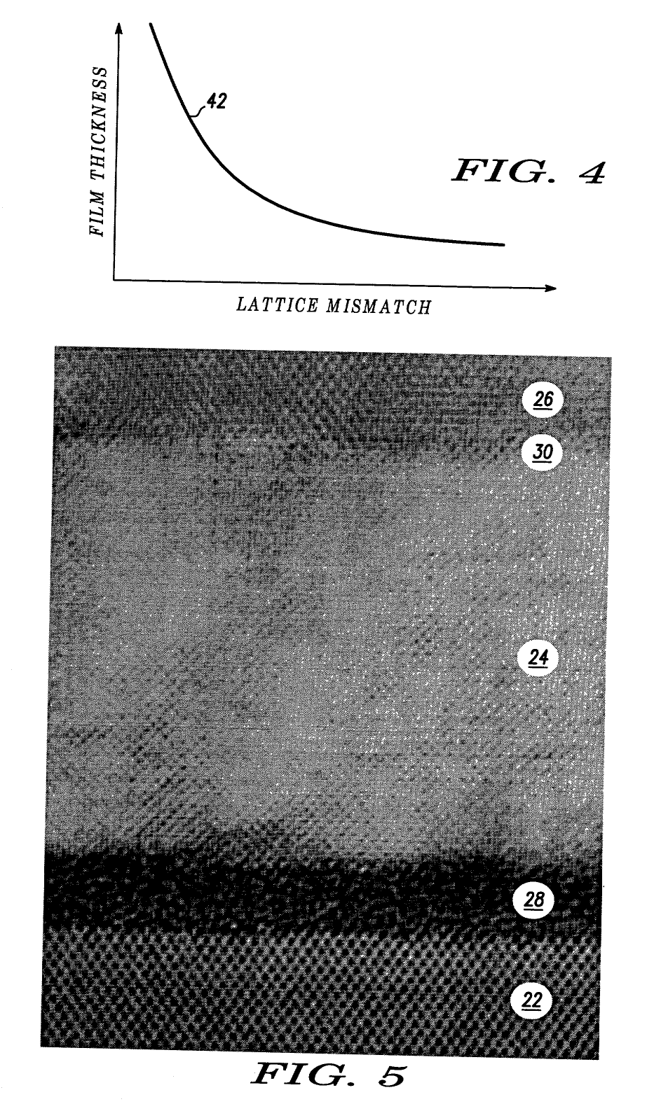

FIG. 4 illustrates graphically the relationship of the achievable thickness of a grown crystal layer of high crystalline quality as a function of the mismatch between the lattice constants of the host crystal and the grown crystal. Curve 42 illustrates the boundary of high crystalline quality material. The area to the right of curve 42 represents layers that have a large number of defects. With no lattice mismatch, it is theoretically possible to grow an infinitely thick, high quality epitaxial layer on the host crystal. As the mismatch in lattice constants increases, the thickness of achievable, high quality crystalline layer decreases rapidly. As a reference point, for example, if the lattice constants between the host crystal and the grown layer are mismatched by more than about 2%, monocrystalline epitaxial layers in excess of about 20 nm cannot be achieved.

In accordance with one embodiment of the invention, substrate 22 is a (100) or (111) oriented monocrystalline silicon wafer and accommodating buffer layer 24 is a layer of strontium barium titanate. Substantial matching of lattice constants between these two materials is achieved by rotating the crystal orientation of the titanate material by 45° with respect to the crystal orientation of the silicon substrate wafer. The inclusion in the structure of amorphous interface layer 28, a silicon oxide layer in this example, if it is of sufficient thickness, serves to reduce strain in the titanate monocrystalline layer that might result from any mismatch in the lattice constants of the host silicon wafer and the grown titanate layer. As a result, in accordance with an embodiment of the invention, a high quality, thick, monocrystalline titanate layer is achievable.

Still referring to FIGS. 1-3, layer 26 is a layer of epitaxially grown monocrystalline material and that crystalline material is also characterized by a crystal lattice constant and a crystal orientation. In accordance with one embodiment of the invention, the lattice constant of layer 26 differs from the lattice constant of substrate 22. To achieve high crystalline quality in this epitaxially grown monocrystalline layer, the accommodating buffer layer must be of high crystalline quality. In addition, in order to achieve high crystalline quality in layer 26, substantial matching between the crystal lattice constant of the host crystal, in this case, the monocrystalline accommodating buffer layer, and the grown crystal is desired. With properly selected materials this substantial matching of lattice constants is achieved as a result of rotation of the crystal orientation of the grown crystal with respect to the orientation of the host crystal. For example, if the grown crystal is gallium arsenide, aluminum gallium arsenide, zinc selenide, or zinc sulfur selenide and the accommodating buffer layer is monocrystalline SrₓBa₁₋ₓTiO₃, substantial matching of crystal lattice constants of the two materials is achieved, wherein the crystal orientation of the grown layer is rotated by 45° with respect to the orientation of the host monocrystalline oxide. Similarly, if the host material is a strontium or barium zirconate or a strontium or barium hafnate or barium tin oxide and the compound semiconductor layer is indium phosphide or gallium indium arsenide or aluminum indium arsenide, substantial matching of crystal lattice constants can be achieved by rotating the orientation of the grown crystal layer by 45° with respect to the host oxide crystal. In some instances, a crystalline semiconductor buffer layer between the host oxide and the grown monocrystalline material layer can be used to reduce strain in the grown monocrystalline material layer that might result from small differences in lattice constants. Better crystalline quality in the grown monocrystalline material layer can thereby be achieved.

The following example illustrates a process, in accordance with one embodiment of the invention, for fabricating a semiconductor structure such as the structures depicted in FIGS. 1-3. The process starts by providing a monocrystalline semiconductor substrate comprising silicon or germanium. In accordance with a preferred embodiment of the invention, the semiconductor substrate is a silicon wafer having a (100) orientation. The substrate is preferably oriented on axis or, at most, about 4° off axis. At least a portion of the semiconductor substrate has a bare surface, although other portions of the substrate, as described below, may encompass other structures. The term “bare” in this context means that the surface in the portion of the substrate has been cleaned to remove any oxides, contaminants, or other foreign material. As is well known, bare silicon is highly reactive and readily forms a native oxide. The term “bare” is intended to encompass such a native oxide. A thin silicon oxide may also be intentionally grown on the semiconductor substrate, although such a grown oxide is not essential to the process in accordance with the invention. In order to epitaxially grow a monocrystalline oxide layer overlying the monocrystalline substrate, the native oxide layer must first be removed to expose the crystalline structure of the underlying substrate. The following process is preferably carried out by molecular beam epitaxy (MBE), although other epitaxial processes may also be used in accordance with the present invention. The native oxide can be removed by first thermally depositing a thin layer of strontium, barium, a combination of strontium and barium, or other alkaline earth metals or combinations of alkaline earth metals in an MBE apparatus. In the case where strontium is used, the substrate is then heated to a temperature of about 750° C. to cause the strontium to react with the native silicon oxide layer. The strontium serves to reduce the silicon oxide to leave a silicon oxide-free surface. The resultant surface, which exhibits an ordered 2×1 structure, includes strontium, oxygen, and silicon. The ordered 2×1 structure forms a template for the ordered growth of an overlying layer of a monocrystalline oxide. The template provides the necessary chemical and physical properties to nucleate the crystalline growth of an overlying layer.

In accordance with an alternate embodiment of the invention, the native silicon oxide can be converted and the substrate surface can be prepared for the growth of a monocrystalline oxide layer by depositing an alkaline earth metal oxide, such as strontium oxide, strontium barium oxide, or barium oxide, onto the substrate surface by MBE at a low temperature and by subsequently heating the structure to a temperature of about 750° C. At this temperature a solid state reaction takes place between the strontium oxide and the native silicon oxide causing the reduction of the native silicon oxide and leaving an ordered 2×1 structure with strontium, oxygen, and silicon remaining on the substrate surface. Again, this forms a template for the subsequent growth of an ordered monocrystalline oxide layer.

Following the removal of the silicon oxide from the surface of the substrate, in accordance with one embodiment of the invention, the substrate is cooled to a temperature in the range of about 200-800° C. and a layer of strontium titanate is grown on the template layer by molecular beam epitaxy. The MBE process is initiated by opening shutters in the MBE apparatus to expose strontium, titanium and oxygen sources. The ratio of strontium and titanium is approximately 1:1. The partial pressure of oxygen is initially set at a minimum value to grow stoichiometric strontium titanate at a growth rate of about 0.3-0.5 nm per minute. After initiating growth of the strontium titanate, the partial pressure of oxygen is increased above the initial minimum value. The overpressure of oxygen causes the growth of an amorphous silicon oxide layer at the interface between the underlying substrate and the growing strontium titanate layer. The growth of the silicon oxide layer results from the diffusion of oxygen through the growing strontium titanate layer to the interface where the oxygen reacts with silicon at the surface of the underlying substrate. The strontium titanate grows as an ordered (100) monocrystal with the (100) crystalline orientation rotated by 45° with respect to the underlying substrate. Strain that otherwise might exist in the strontium titanate layer because of the small mismatch in lattice constant between the silicon substrate and the growing crystal is relieved in the amorphous silicon oxide intermediate layer.

After the strontium titanate layer has been grown to the desired thickness, the monocrystalline strontium titanate is capped by a template layer that is conducive to the subsequent growth of an epitaxial layer of a desired monocrystalline material. For example, for the subsequent growth of a monocrystalline compound semiconductor material layer of gallium arsenide, the MBE growth of the strontium titanate monocrystalline layer can be capped by terminating the growth with 1-2 monolayers of titanium, 1-2 monolayers of titanium-oxygen or with 1-2 monolayers of strontium-oxygen. Following the formation of this capping layer, arsenic is deposited to form a Ti—As bond, a Ti—O—As bond or a Sr—O—As. Any of these form an appropriate template for deposition and formation of a gallium arsenide monocrystalline layer. Following the formation of the template, gallium is subsequently introduced to the reaction with the arsenic and gallium arsenide forms. Alternatively, gallium can be deposited on the capping layer to form a Sr—O—Ga bond, and arsenic is subsequently introduced with the gallium to form the GaAs.

FIG. 5 is a high resolution Transmission Electron Micrograph (TEM) of semiconductor material manufactured in accordance with one embodiment of the present invention. Single crystal SrTiO₃ accommodating buffer layer 24 was grown epitaxially on silicon substrate 22. During this growth process, amorphous interfacial layer 28 is formed which relieves strain due to lattice mismatch. GaAs compound semiconductor layer 26 was then grown epitaxially using template layer 30.

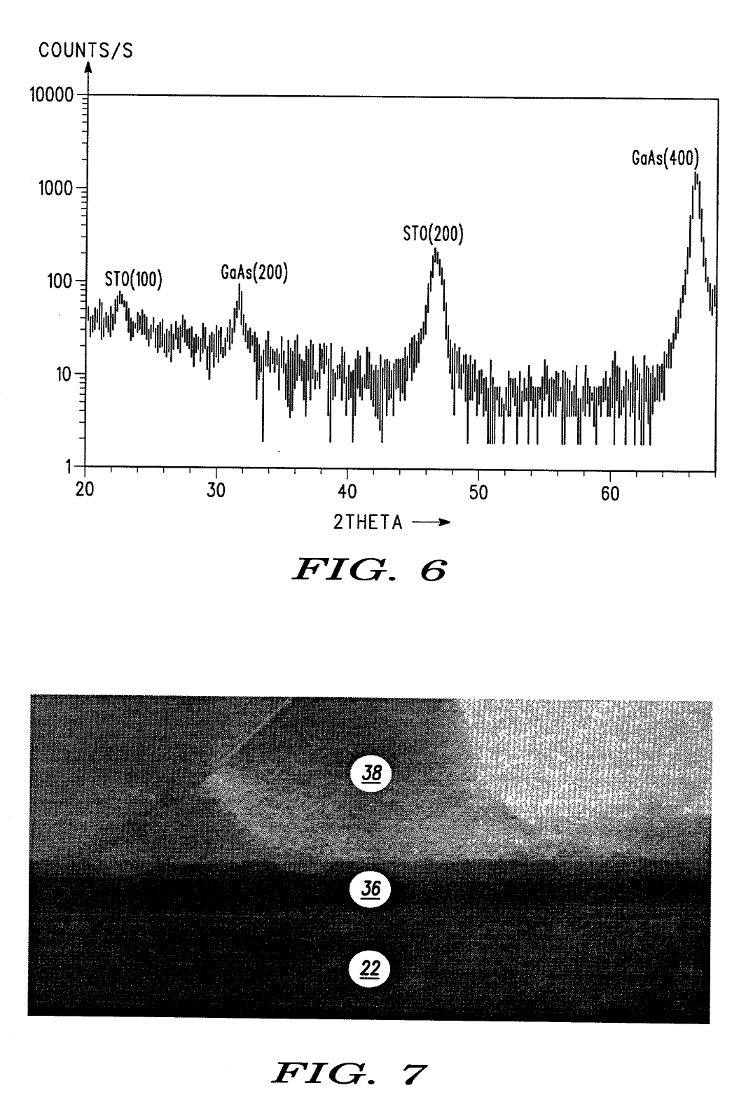

FIG. 6 illustrates an x-ray diffraction spectrum taken on a structure including GaAs monocrystalline layer 26 comprising GaAs grown on silicon substrate 22 using accommodating buffer layer 24. The peaks in the spectrum indicate that both the accommodating buffer layer 24 and GaAs compound semiconductor layer 26 are single crystal and (100) orientated.

The structure illustrated in FIG. 2 can be formed by the process discussed above with the addition of an additional buffer layer deposition step. The additional buffer layer 32 is formed overlying the template layer before the deposition of the monocrystalline material layer. If the buffer layer is a monocrystalline material comprising a compound semiconductor superlattice, such a superlattice can be deposited, by MBE for example, on the template described above. If instead the buffer layer is a monocrystalline material layer comprising a layer of germanium, the process above is modified to cap the strontium titanate monocrystalline layer with a final layer of either strontium or titanium and then by depositing germanium to react with the strontium or titanium. The germanium buffer layer can then be deposited directly on this template.

Structure 34, illustrated in FIG. 3, may be formed by growing an accommodating buffer layer, forming an amorphous oxide layer over substrate 22, and growing semiconductor layer 38 over the accommodating buffer layer, as described above. The accommodating buffer layer and the amorphous oxide layer are then exposed to an anneal process sufficient to change the crystalline structure of the accommodating buffer layer from monocrystalline to amorphous, thereby forming an amorphous layer such that the combination of the amorphous oxide layer and the now amorphous accommodating buffer layer form a single amorphous oxide layer 36. Layer 26 is then subsequently grown over layer 38. Alternatively, the anneal process may be carried out subsequent to growth of layer 26.

In accordance with one aspect of this embodiment, layer 36 is formed by exposing substrate 22, the accommodating buffer layer, the amorphous oxide layer, and monocrystalline layer 38 to a rapid thermal anneal process with a peak temperature of about 700° C. to about 1000° C. and a process time of about 5 seconds to about 10 minutes. However, other suitable anneal processes may be employed to convert the accommodating buffer layer to an amorphous layer in accordance with the present invention. For example, laser annealing, electron beam annealing, or “conventional” thermal annealing processes (in the proper environment) may be used to form layer 36. When conventional thermal annealing is employed to form layer 36, an overpressure of one or more constituents of layer 30 may be required to prevent degradation of layer 38 during the anneal process. For example, when layer 38 includes GaAs, the anneal environment preferably includes an overpressure of arsenic to mitigate degradation of layer 38.

As noted above, layer 38 of structure 34 may include any materials suitable for either of layers 32 or 26. Accordingly, any deposition or growth methods described in connection with either layer 32 or 26, may be employed to deposit layer 38.

FIG. 7 is a high resolution TEM of semiconductor material manufactured in accordance with the embodiment of the invention illustrated in FIG. 3. In accordance with this embodiment, a single crystal SrTiO₃ accommodating buffer layer was grown epitaxially on silicon substrate 22. During this growth process, an amorphous interfacial layer forms as described above. Next, additional monocrystalline layer 38 comprising a compound semiconductor layer of GaAs is formed above the accommodating buffer layer and the accommodating buffer layer is exposed to an anneal process to form amorphous oxide layer 36.

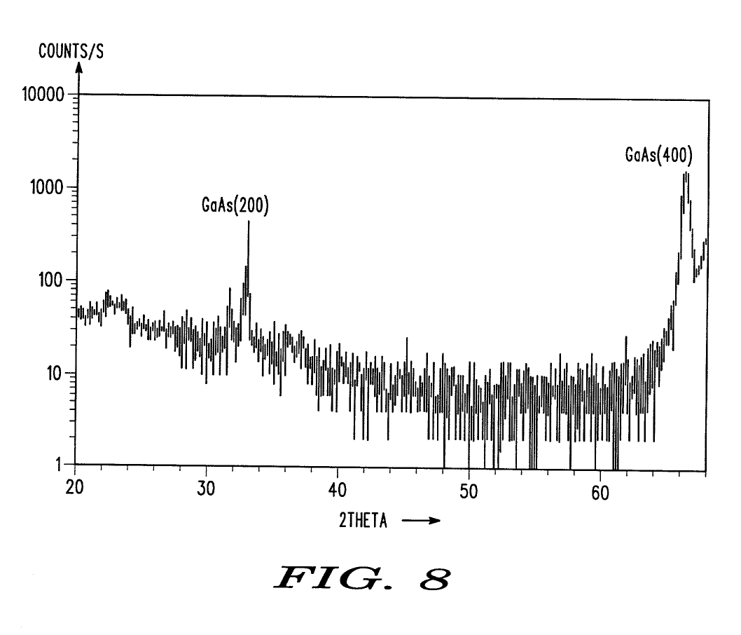

FIG. 8 illustrates an x-ray diffraction spectrum taken on a structure including additional monocrystalline layer 38 comprising a GaAs compound semiconductor layer and amorphous oxide layer 36 formed on silicon substrate 22. The peaks in the spectrum indicate that GaAs compound semiconductor layer 38 is single crystal and (100) orientated and the lack of peaks around 40 to 50 degrees indicates that layer 36 is amorphous.

The process described above illustrates a process for forming a semiconductor structure including a silicon substrate, an overlying oxide layer, and a monocrystalline material layer comprising a gallium arsenide compound semiconductor layer by the process of molecular beam epitaxy. The process can also be carried out by the process of chemical vapor deposition (CVD), metal organic chemical vapor deposition (MOCVD), migration enhanced epitaxy (MEE), atomic layer epitaxy (ALE), physical vapor deposition (PVD), chemical solution deposition (CSD), pulsed laser deposition (PLD), or the like. Further, by a similar process, other monocrystalline accommodating buffer layers such as alkaline earth metal titanates, zirconates, hafnates, tantalates, vanadates, ruthenates, and niobates, alkaline earth metal tin-based perovskites, lanthanum aluminate, lanthanum scandium oxide, and gadolinium oxide can also be grown. Further, by a similar process such as MBE, other monocrystalline material layers comprising other III-V and II-VI monocrystalline compound semiconductors, semiconductors, metals and non-metals can be deposited overlying the monocrystalline oxide accommodating buffer layer.

Each of the variations of monocrystalline material layer and monocrystalline oxide accommodating buffer layer uses an appropriate template for initiating the growth of the monocrystalline material layer. For example, if the accommodating buffer layer is an alkaline earth metal zirconate, the oxide can be capped by a thin layer of zirconium. The deposition of zirconium can be followed by the deposition of arsenic or phosphorus to react with the zirconium as a precursor to depositing indium gallium arsenide, indium aluminum arsenide, or indium phosphide respectively. Similarly, if the monocrystalline oxide accommodating buffer layer is an alkaline earth metal hafnate, the oxide layer can be capped by a thin layer of hafnium. The deposition of hafnium is followed by the deposition of arsenic or phosphorous to react with the hafnium as a precursor to the growth of an indium gallium arsenide, indium aluminum arsenide, or indium phosphide layer, respectively. In a similar manner, strontium titanate can be capped with a layer of strontium or strontium and oxygen and barium titanate can be capped with a layer of barium or barium and oxygen. Each of these depositions can be followed by the deposition of arsenic or phosphorus to react with the capping material to form a template for the deposition of a monocrystalline material layer comprising compound semiconductors such as indium gallium arsenide, indium aluminum arsenide, or indium phosphide.

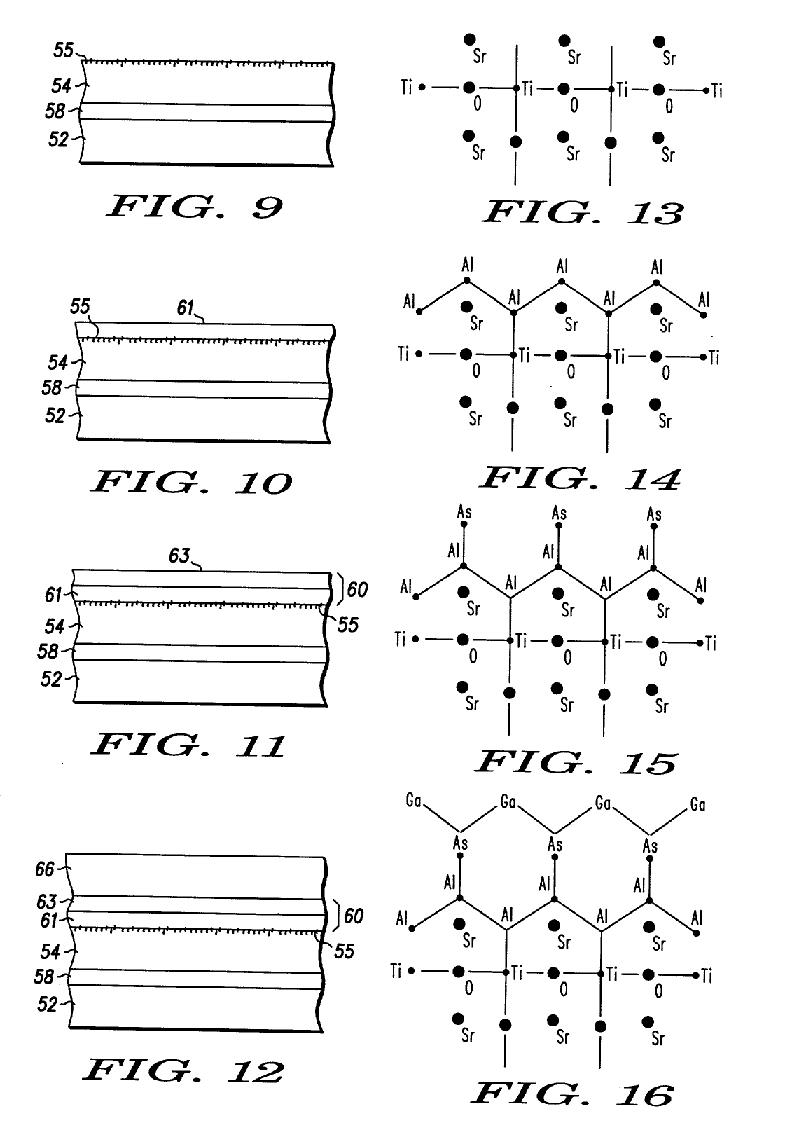

The formation of a device structure in accordance with another embodiment of the invention is illustrated schematically in cross-section in FIGS. 9-12. Like the previously described embodiments referred to in FIGS. 1-3, this embodiment of the invention involves the process of forming a compliant substrate utilizing the epitaxial growth of single crystal oxides, such as the formation of accommodating buffer layer 24 previously described with reference to FIGS. 1 and 2 and amorphous layer 36 previously described with reference to FIG. 3, and the formation of a template layer 30. However, the embodiment illustrated in FIGS. 9-12 utilizes a template that includes a surfactant to facilitate layer-by-layer monocrystalline material growth.

Turning now to FIG. 9, an amorphous intermediate layer 58 is grown on substrate 52 at the interface between substrate 52 and a growing accommodating buffer layer 54, which is preferably a monocrystalline crystal oxide layer, by the oxidation of substrate 52 during the growth of layer 54. Layer 54 is preferably a monocrystalline oxide material such as a monocrystalline layer of Sr_{z}Ba_{1-z}TiO₃ where z ranges from 0 to 1. However, layer 54 may also comprise any of those compounds previously described with reference layer 24 in FIGS. 1-2 and any of those compounds previously described with reference to layer 36 in FIG. 3, which is formed from layers 24 and 28 referenced in FIGS. 1 and 2.

Layer 54 is grown with a strontium (Sr) terminated surface represented in FIG. 9 by hatched line 55 which is followed by the addition of a template layer 60 which includes a surfactant layer 61 and capping layer 63 as illustrated in FIGS. 10 and 11. Surfactant layer 61 may comprise, but is not limited to, elements such as Al, In and Ga, but will be dependent upon the composition of layer 54 and the overlying layer of monocrystalline material for optimal results. In one exemplary embodiment, aluminum (Al) is used for surfactant layer 61 and functions to modify the surface and surface energy of layer 54. Preferably, surfactant layer 61 is epitaxially grown, to a thickness of one to two monolayers, over layer 54 as illustrated in FIG. 10 by way of molecular beam epitaxy (MBE), although other epitaxial processes may also be performed including chemical vapor deposition (CVD), metal organic chemical vapor deposition (MOCVD), migration enhanced epitaxy (MEE), atomic layer epitaxy (ALE), physical vapor deposition (PVD), chemical solution deposition (CSD), pulsed laser deposition (PLD), or the like.

Surfactant layer 61 is then exposed to a Group V element such as arsenic, for example, to form capping layer 63 as illustrated in FIG. 11. Surfactant layer 61 may be exposed to a number of materials to create capping layer 63 such as elements which include, but are not limited to, As, P, Sb and N. Surfactant layer 61 and capping layer 63 combine to form template layer 60.

Monocrystalline material layer 66, which in this example is a compound semiconductor such as GaAs, is then deposited via MBE, CVD, MOCVD, MEE, ALE, PVD, CSD, PLD, and the like to form the final structure illustrated in FIG. 12.

FIGS. 13-16 illustrate possible molecular bond structures for a specific example of a compound semiconductor structure formed in accordance with the embodiment of the invention illustrated in FIGS. 9-12. More specifically, FIGS. 13-16 illustrate the growth of GaAs (layer 66) on the strontium terminated surface of a strontium titanate monocrystalline oxide (layer 54) using a surfactant containing template (layer 60).

The growth of a monocrystalline material layer 66 such as GaAs on an accommodating buffer layer 54 such as a strontium titanium oxide over amorphous interface layer 58 and substrate layer 52, both of which may comprise materials previously described with reference to layers 28 and 22, respectively in FIGS. 1 and 2, illustrates a critical thickness of about 1000 Angstroms where the two-dimensional (2D) and three-dimensional (3D) growth shifts because of the surface energies involved. In order to maintain a true layer by layer growth (Frank Van der Mere growth), the following relationship must be satisfied:

δ_{STO}>(δ_{INT}+δ_{GaAs})

where the surface energy of the monocrystalline oxide layer 54 must be greater than the surface energy of the amorphous interface layer 58 added to the surface energy of the GaAs layer 66. Since it is impracticable to satisfy this equation, a surfactant containing template was used, as described above with reference to FIGS. 10-12, to increase the surface energy of the monocrystalline oxide layer 54 and also to shift the crystalline structure of the template to a diamond-like structure that is in compliance with the original GaAs layer.

FIG. 13 illustrates the molecular bond structure of a strontium terminated surface of a strontium titanate monocrystalline oxide layer. An aluminum surfactant layer is deposited on top of the strontium terminated surface and bonds with that surface as illustrated in FIG. 14, which reacts to form a capping layer comprising a monolayer of Al₂Sr having the molecular bond structure illustrated in FIG. 14 which forms a diamond-like structure with an sp³ hybrid terminated surface that is compliant with compound semiconductors such as GaAs. The structure is then exposed to As to form a layer of AlAs as shown in FIG. 15. GaAs is then deposited to complete the molecular bond structure illustrated in FIG. 16, which has been obtained by 2D growth. The GaAs can be grown to any thickness for forming other semiconductor structures, devices, or integrated circuits. Alkaline earth metals such as those in Group IIA are those elements preferably used to form the capping surface of the monocrystalline oxide layer 54 because they are capable of forming a desired molecular structure with aluminum.

In this embodiment, a surfactant containing template layer aids in the formation of a compliant substrate for the monolithic integration of various material layers including those comprised of Group III-V compounds to form high quality semiconductor structures, devices and integrated circuits. For example, a surfactant containing template may be used for the monolithic integration of a monocrystalline material layer such as a layer comprising Germanium (Ge), for example, to form high efficiency photocells.

Turning now to FIGS. 17-20, the formation of a device structure in accordance with still another embodiment of the invention is illustrated in cross-section. This embodiment utilizes the formation of a compliant substrate, which relies on the epitaxial growth of single crystal oxides on silicon followed by the epitaxial growth of single crystal silicon onto the oxide.

An accommodating buffer layer 74 such as a monocrystalline oxide layer is first grown on a substrate layer 72, such as silicon, with an amorphous interface layer 78 as illustrated in FIG. 17. Monocrystalline oxide layer 74 may be comprised of any of those materials previously discussed with reference to layer 24 in FIGS. 1 and 2, while amorphous interface layer 78 is preferably comprised of any of those materials previously described with reference to the layer 28 illustrated in FIGS. 1 and 2. Substrate 72, although preferably silicon, may also comprise any of those materials previously described with reference to substrate 22 in FIGS. 1-3.

Next, a silicon layer 81 is deposited over monocrystalline oxide layer 74 via MBE, CVD, MOCVD, MEE, ALE, PVD, CSD, PLD, and the like as illustrated in FIG. 18 with a thickness of a few hundred Angstroms but preferably with a thickness of about 50 Angstroms. Monocrystalline oxide layer 74 preferably has a thickness of about 20 to 100 Angstroms.

Rapid thermal annealing is then conducted in the presence of a carbon source such as acetylene or methane, for example at a temperature within a range of about 800° C. to 1000° C. to form capping layer 82 and silicate amorphous layer 86. However, other suitable carbon sources may be used as long as the rapid thermal annealing step functions to amorphize the monocrystalline oxide layer74 into a silicate amorphous layer 86 and carbonize the top silicon layer 81 to form capping layer 82 which in this example would be a silicon carbide (SiC) layer as illustrated in FIG. 19. The formation of amorphous layer 86 is similar to the formation of layer 36 illustrated in FIG. 3 and may comprise any of those materials described with reference to layer 36 in FIG. 3 but the preferable material will be dependent upon the capping layer 82 used for silicon layer 81.

Finally, a compound semiconductor layer 96, such as gallium nitride (GaN) is grown over the SiC surface by way of MBE, CVD, MOCVD, MEE, ALE, PVD, CSD, PLD, or the like to form a high quality compound semiconductor material for device formation. More specifically, the deposition of GaN and GaN based systems such as GaInN and AlGaN will result in the formation of dislocation nets confined at the silicon/amorphous region. The resulting nitride containing compound semiconductor material may comprise elements from groups III, IV and V of the periodic table and is defect free.

Although GaN has been grown on SiC substrate in the past, this embodiment of the invention possesses a one step formation of the compliant substrate containing a SiC top surface and an amorphous layer on a Si surface. More specifically, this embodiment of the invention uses an intermediate single crystal oxide layer that is amorphosized to form a silicate layer, which adsorbs the strain between the layers. Moreover, unlike past use of a SiC substrate, this embodiment of the invention is not limited by wafer size, which is usually less than 50 mm in diameter for prior art SiC substrates.

The monolithic integration of nitride containing semiconductor compounds containing group III-V nitrides and silicon devices can be used for high temperature RF applications and optoelectronics. GaN systems have particular use in the photonic industry for the blue/green and UV light sources and detection. High brightness light emitting diodes (LEDs) and lasers may also be formed within the GaN system.

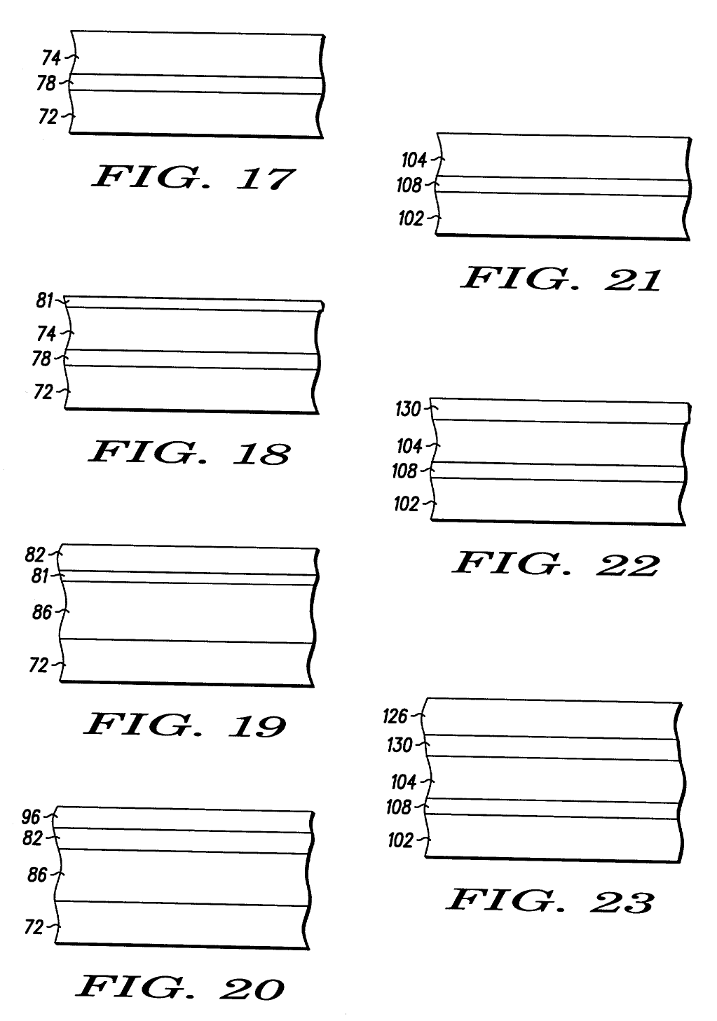

FIGS. 21-23 schematically illustrate, in cross-section, the formation of another embodiment of a device structure in accordance with the invention. This embodiment includes a compliant layer that functions as a transition layer that uses clathrate or Zintl type bonding. More specifically, this embodiment utilizes an intermetallic template layer to reduce the surface energy of the interface between material layers thereby allowing for two dimensional layer by layer growth.

The structure illustrated in FIG. 21 includes a monocrystalline substrate 102, an amorphous interface layer 108 and an accommodating buffer layer 104. Amorphous interface layer 108 is formed on substrate 102 at the interface between substrate 102 and accommodating buffer layer 104 as previously described with reference to FIGS. 1 and 2. Amorphous interface layer 108 may comprise any of those materials previously described with reference to amorphous interface layer 28 in FIGS. 1 and 2. Substrate 102 is preferably silicon but may also comprise any of those materials previously described with reference to substrate 22 in FIGS. 1-3.

A template layer 130 is deposited over accommodating buffer layer 104 as illustrated in FIG. 22 and preferably comprises a thin layer of Zintl type phase material composed of metals and metalloids having a great deal of ionic character. As in previously described embodiments, template layer 130 is deposited by way of MBE, CVD, MOCVD, MEE, ALE, PVD, CSD, PLD, or the like to achieve a thickness of one monolayer. Template layer 130 functions as a “soft” layer with non-directional bonding but high crystallinity, which absorbs stress build up between layers having lattice mismatch. Materials for template 130 may include, but are not limited to, materials containing Si, Ga, In, and Sb such as, for example, AlSr₂, (MgCaYb)Ga₂, (Ca,Sr,Eu,Yb)In₂, BaGe₂As, and SrSn₂As₂

A monocrystalline material layer 126 is epitaxially grown over template layer 130 to achieve the final structure illustrated in FIG. 23. As a specific example, an SrAl₂ layer may be used as template layer 130 and an appropriate monocrystalline material layer 126 such as a compound semiconductor material GaAs is grown over the SrAl₂. The Al—Ti (from the accommodating buffer layer of layer of Sr_{z}Ba_{1-z}TiO₃ where z ranges from 0 to 1) bond is mostly metallic while the Al—As (from the GaAs layer) bond is weakly covalent. The Sr participates in two distinct types of bonding with part of its electric charge going to the oxygen atoms in the lower accommodating buffer layer 104 comprising Sr_{z}Ba_{1-z}TiO₃ to participate in ionic bonding and the other part of its valence charge being donated to Al in a way that is typically carried out with Zintl phase materials. The amount of the charge transfer depends on the relative electronegativity of elements comprising the template layer 130 as well as on the interatomic distance. In this example, Al assumes an Sp₃ hybridization and can readily form bonds with monocrystalline material layer 126, which in this example, comprises compound semiconductor material GaAs.

The compliant substrate produced by use of the Zintl type template layer used in this embodiment can absorb a large strain without a significant energy cost. In the above example, the bond strength of the Al is adjusted by changing the volume of the SrAI₂ layer thereby making the device tunable for specific applications, which include the monolithic integration of III-V and Si devices and the monolithic integration of high-k dielectric materials for CMOS technology.

Clearly, those embodiments specifically describing structures having compound semiconductor portions and Group IV semiconductor portions, are meant to illustrate embodiments of the present invention and not limit the present invention. There are a multiplicity of other combinations and other embodiments of the present invention. For example, the present invention includes structures and methods for fabricating material layers, which form semiconductor structures, devices and integrated circuits including other layers such as metal and non-metal layers. More specifically, the invention includes structures and methods for forming a compliant substrate, which is used in the fabrication of semiconductor structures, devices and integrated circuits and the material layers suitable for fabricating those structures, devices, and integrated circuits. By using embodiments of the present invention, it is now simpler to integrate devices that include monocrystalline layers comprising semiconductor and compound semiconductor materials as well as other material layers that are used to form those devices with other components that work better or are easily and/or inexpensively formed within semiconductor or compound semiconductor materials. This allows a device to be shrunk, the manufacturing costs to decrease, and yield and reliability to increase.

In accordance with one embodiment of this invention, a monocrystalline semiconductor or compound semiconductor wafer can be used in forming monocrystalline material layers over the wafer. In this manner, the wafer is essentially a “handle” wafer used during the fabrication of semiconductor electrical components within a monocrystalline layer overlying the wafer. Therefore, electrical components can be formed within semiconductor materials over a wafer of at least approximately 200 millimeters in diameter and possibly at least approximately 300 millimeters.

By the use of this type of substrate, a relatively inexpensive “handle” wafer overcomes the fragile nature of compound semiconductor or other monocrystalline material wafers by placing them over a relatively more durable and easy to fabricate base material. Therefore, an integrated circuit can be formed such that all electrical components, and particularly all active electronic devices, can be formed within or using the monocrystalline material layer even though the substrate itself may include a monocrystalline semiconductor material. Fabrication costs for compound semiconductor devices and other devices employing non-silicon monocrystalline materials should decrease because larger substrates can be processed more economically and more readily compared to the relatively smaller and more fragile substrates (e.g. conventional compound semiconductor wafers).

One semiconductor device that can be formed within or using the monocrystalline material layers is an apparatus for analyzing target materials. The apparatus for analyzing target materials can be formed such that multiple semiconductor lasers are formed from a compound semiconductor portion, with at least two of the multiple semiconductor lasers configured to emit radiation (e.g., light) with different wavelengths. The apparatus can be utilized for analyzing any number of target materials as will be subsequently described in this detailed description of the drawings.

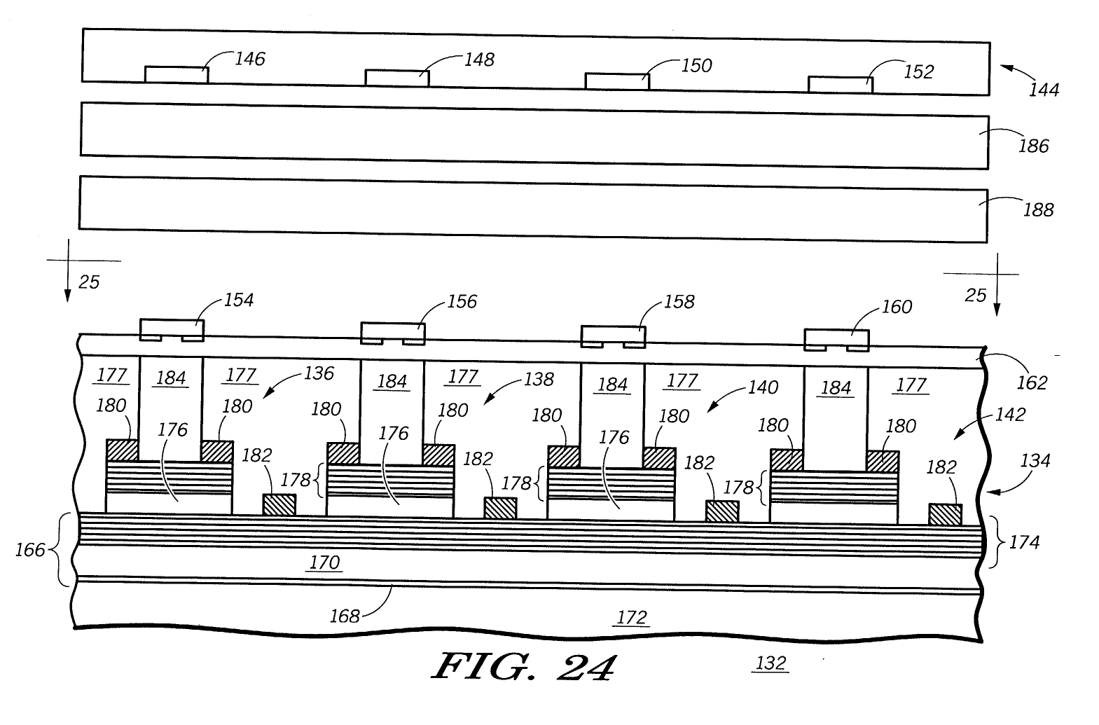

Referring to FIG. 24, an apparatus 132 for analyzing target materials is illustrated according to an embodiment of the present invention. The apparatus 132 for analyzing target materials is preferably comprised of a semiconductor structure 134 with multiple semiconductor lasers (136,138,140,142), a semiconductor structure 144 with multiple detectors (146,148,150,152) and multiple receptacles (154,156,158,160) that are preferably supported by an assay support structure 162. The multiple receptacles (154,156,158,160) are preferably interposed between the semiconductor lasers (136,138,140,142) and the detectors (146,148,150,152).

The semiconductor structure 134 with multiple semiconductor lasers (136,138,140,142) is configured such that at least one of the multiple semiconductor lasers (136,138,140,142) (e.g., the first semiconductor laser 136) is configured to emit radiation (e.g., light) with a first wavelength and at least one of the other semiconductor lasers (138,140,142) (e.g., the second semiconductor laser 138) is configured to emit radiation (e.g., light) with a second wavelength other than the first wavelength. In addition, the semiconductor structure 144 with multiple receptacles (154,156,158,160) is configured such that at least two of the receptacles (154,156,158,160) (e.g., the first receptacle 154 and the second receptacle 156) are configured to receive target materials and at least one of these two receptacles (e.g., the first receptacle 154) is configured to receive radiation with the first wavelength and at least the other receptacle (e.g., the second receptacle 156) is configured to receive radiation with the second wavelength. The semiconductor structure 144 with the multiple detectors (146,148,150,152) is configured to receive radiation emissions from target materials contained in at least two of the receptacles (e.g., the first receptacle 154 and the second receptacle 156) that are produced at least in part with the reception of the radiation with the first wavelength and second wavelength.

For example, the apparatus 132 can be configured to emit light with a first wavelength toward a target material contained by the first receptacle 154 using the first semiconductor laser 136 and analyze light detected by the first detector 146 that emerges from the target material contained in the first receptacle 154. In addition, the apparatus 132 can be configured to emit light with a second wavelength toward a target material contained by the second receptacle 156 using the second semiconductor laser 138 and analyze light detected by the second detector 148 that emerges from the target material contained in the second receptacle 156. Furthermore, other light can be emitted with the first wavelength, second wavelength or wavelengths other than the first wavelength and the second wavelength (e.g., third wavelength, fourth wavelength, fifth wavelength, etc.) toward a target material contained by the third receptacle 158, fourth receptacle 160 and/or any other receptacle using the third semiconductor laser 140, fourth semiconductor laser 142 and/or any other semiconductor laser and light emerging from the target materials contained in the third receptacle 158, fourth receptacle 160 and/or any other receptacle can be received by the third detector 150, fourth detector 152 and/or other detectors for analysis.

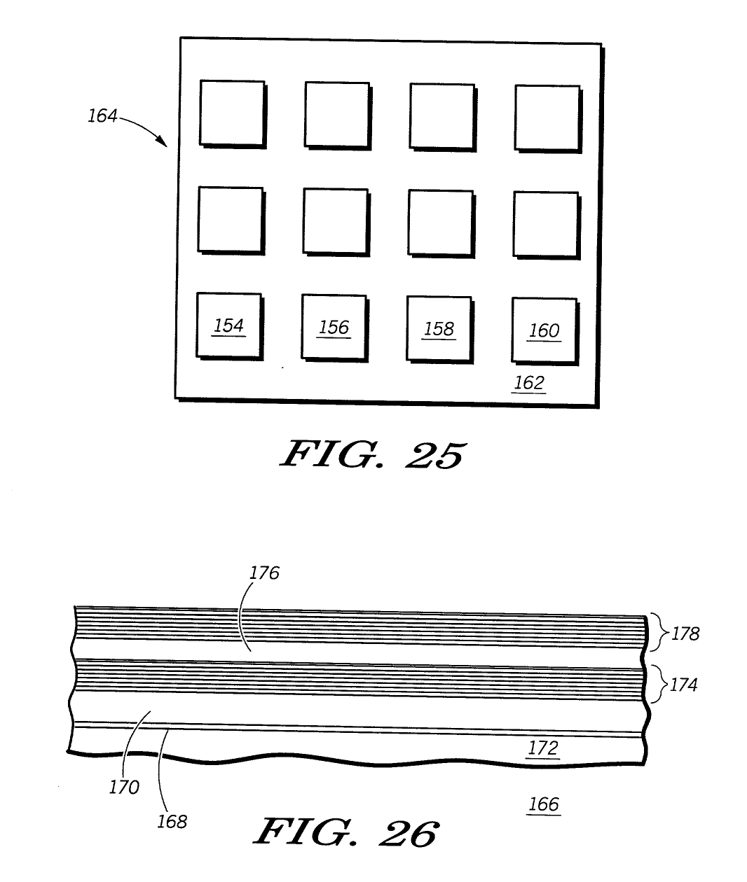

As previously described in this detailed description of the drawings, the receptacles (154,156,158,160) are preferably supported by an assay support structure 162. The assay support structure 162 can be formed of any suitable material. For example, the assay support structure 162 can be formed of glass, plastic or semiconductor materials such as silicon, which is suitably modified to be compatible with the target material. While the assay support structure 162 illustrated in FIG. 24 is supporting four receptacles, any number of receptacles can be utilized in accordance with the present invention. In addition, the receptacles can be arranged to form an assay array such as the assay array 164 illustrated in FIG. 25. However, any number of assay array configurations can be used according to the present invention.

Continuing with reference to FIG. 24, the receptacles (154,156,158,160) can be configured to contain any number of gases, liquids, solids, semi-solids or the like. For example, one or more of the receptacles (154,156,158,160) can be a cavity formed to contain a target material or one or more of the receptacles (154,156,158,160) can be a target pad. More specifically, and by way of illustration only, one or more of the receptacles (154,156,158,160) can be target pads that include materials that react with or bond to the target materials. For example, receptacles that are configured as target pads can include suitable DNA oligos that are designed to attract particular NDA oligos of the target materials for a DNA analysis.

The receptacles (154,156,158,160) can be formed with a variety of techniques. For example, cavity receptacles can be formed with the selective removal of material from the assay support structure 162 using any number of techniques, including, but not limited to photolithographic patterning and wet and/or dry etching after the photolithographic patterning. As another example, target pad receptacles can be formed by photolithographically patterning a porous gel such as agarose or polyacrylamide and spotting properly conjugated agents and DNA probes onto the gel using techniques such as ink jet technology or selectively and chemically activating areas to attach DNA material.

The receptacles (154,156,158,160) can also be subjected to additional processing to facilitate analysis of the target materials. For example, a fluorescent tag or marker can be provided with the receptacles (154,156,158,160) to facilitate detection of particular oligos in the target material. The fluorescent tags or markers can be excited at a particular wavelength longer than the wavelength of the incident light. Exemplary fluorescent tag materials include, but are not limited to, Cyanine 6 (excitation=630 nm, emission=650 nm), Cyanine 3 (excitation=530 nm, emission=550 nm), Texan Red 5 (excitation=530 nm, emission=550 nm), and Tamra 5 (excitation=530 nm, emission=550 nm).

As previously described in this detailed description of the drawings, at least two of the receptacles (154,156,158,160) (e.g., the first receptacle 154 and the second receptacle 156) are configured to receive target materials and at least one of the receptacles (e.g., the first receptacle 154) is configured to receive radiation with the first wavelength emitted from one of the semiconductor lasers (136,138,140,142) (e.g., the first semiconductor laser 136) and at least one of the other receptacles (138,140,142) (e.g., the second receptacle 156) is configured to receive radiation with the second wavelength emitted from at least one of the other semiconductor lasers (138,140,142) (e.g., the second semiconductor laser 138). However, a greater number of receptacles than the at least two receptacles are preferably utilized according to the present invention and preferably configured to receive radiation from the multiple semiconductor lasers (136,138,140,142), which are preferably configured to emit radiation with wavelengths other than the first wavelength and the second wavelength. For example, the third receptacle 158 can be configured to receive radiation emitted by the third semiconductor laser 140 with a third wavelength other than the first wavelength and the second wavelength and the fourth receptacle 160 can be configured to receive radiation emitted by the fourth semiconductor laser 142 with a fourth wavelength other than the first wavelength, the second wavelength or the third wavelength. Furthermore, while this detailed description of the drawings provides an illustrative embodiment with one semiconductor laser for each receptacle, a semiconductor laser can be configured to emit radiation (e.g., light) toward and excite target material contained in multiple receptacles.

The multiple semiconductor lasers (136,138,140,142) are formed at least in part from a compound semiconductor portion 166 that is comprised of an amorphous intermediate layer 168 and an accommodating buffer layer 170, similar to those previously described, having been formed over wafer 172 as illustrated in FIG. 26. While the following detailed description of the drawings will describe vertical cavity surface emitting lasers (VCSELS), any number of semiconductor laser configurations can be formed at least in part from the compound semiconductor portion 166. For example, light emitting diodes, edge-emitting lasers or a combination of light emitting diodes, edge emitting lasers and VCSELS can be formed at least in part from the compound semiconductor portion 166.

Referring to FIG. 26, the amorphous intermediate layer 168 and the accommodating buffer layer 170 may be subject to an annealing process as described above in connection with FIG. 3 to form a single amorphous accommodating layer. In addition, a lower mirror layer 174 is preferable provided that includes alternating layers of compound semiconductor materials. For example, the first, third, and fifth films within the lower mirror layer 174 may include a material such as gallium arsenide, and the second, fourth, and sixth films within the lower mirror layer 174 may include aluminum gallium arsenide or vice versa. An active layer 176 is preferably provided that will be the active region of the semiconductor lasers and used for photon generation and an upper mirror layer 178 is preferably provided and formed in a similar manner to the lower mirror layer 174 and includes alternating films of compound semiconductor materials. In one particular embodiment, the upper mirror layer 178 may be p-type doped compound semiconductor materials, and the lower mirror layer 174 may be one or more n-type doped compound semiconductor materials.

The wavelengths of the semiconductor lasers (136,138,140,142) can be provided in a well-known manner with the selection of the materials for the alternating films of the lower mirror layer 174, the selection of the materials for the alternating films of the upper mirror layer 178 and the selection of the material for the active layer 176. In order to provide the multiple wavelengths, the semiconductor lasers (136,138,140,142) are individually fabricated with materials for the alternating films of the lower mirror layer 174, the selection of the materials for the alternating films of the upper mirror layer 178 and the selection of the material for the active layer 176 to provided a desired wavelength for a particular laser. The semiconductor lasers (136,138,140,142) can be formed in any order and multiple lasers with the same or substantially the same wavelength can be formed in accordance with the present invention.

For example and with reference to FIG. 24, after the amorphous intermediate layer 168 and the accommodating buffer layer 170 are formed in accordance with the present invention, the alternating layers of the lower mirror layer 174, the active layer 176 and the alternating layers of the upper mirror layers are formed for the first semiconductor laser 136 using any number well-known techniques. Additional steps are performed to define the upper mirror layer 178 and active layer 176 for the first semiconductor laser 136 (e.g., the sides of the upper mirror layer 178 and active layer 176 are formed to be substantially coterminous). Once the upper mirror layer 174 and active layer 176 are formed for the first semiconductor laser 136, a passivation layer (not shown) is deposited over the existing structure of the first semiconductor laser 136. The passivation layer can be any number of materials that is configured to protect the existing structure of the first semiconductor laser 136 during subsequent etching steps, such as silicon dioxide or silicon nitride.

After the passivation layer is deposited over the existing structure of the first semiconductor laser 136, the semiconductor structure 134 is subjected to an etching process that removes material except for the material formed over the accommodating buffer layer 170 and the material protected by the passivation layer (i.e., the existing structure of the first semiconductor laser 136). Once this etch of the material formed over the accommodating buffer layer 170 is conducted, the alternating layers of the lower mirror layer 174, the active layer 176 and the alternating layers of the upper mirror layer 178 are formed for the second semiconductor laser 138 using any number well-known techniques to provide a semiconductor laser with a second wavelength other than the first wavelength. Additional steps are performed to define the upper mirror layer 178 and active layer 176 for the second semiconductor laser 138 (e.g., the sides of the upper mirror layer 178 and active layer 176 are formed to be substantially coterminous). This process is repeated for each of the desired wavelengths of the semiconductor lasers and the passivation layer is removed after the multiple semiconductor lasers (136,138,140,142) with at least a first wavelength and a second wavelength other than the first wavelength is formed according to the present invention. After the passivation layer is removed, a first contact 180 and a second contact 182 are formed for making electrical contact to the upper mirror layer 178 and the lower mirror layer 174, respectively. The first contact 180 preferably has an annular shape to allow radiation (e.g., light photons) to pass out of the upper mirror layer 178.

Optical openings 184 are preferably formed from the upper mirror layer 178. The optical openings 184 are preferably formed in a receptacle support layer 177 of the semiconductor assay structure 134. The receptacle support layer 177 can have any number of configurations and can be formed of any number of materials, including, but not limited to, an oxide, nitride, oxynitride, low-k dielectric, or any combination thereof. After the optical openings 184 are formed in the receptacle support layer 177, a higher refractive index material (not shown) is preferably formed within the optical openings 184 to at least partially and preferably substantially fills the optical openings 184. With respect to the higher refractive index material, “higher” is in relation to the material of the receptacle support layer 177 (i.e., material in the optical openings 184 has a higher refractive index compared to the material forming the receptacle support layer 177). The optical openings 184 provide waveguides for the radiation (e.g., light) emitted from the semiconductor lasers (136,138,140,142) to the receptacles (154,156,158,160), which impinges upon the target materials contained by the receptacles (154,156,158,160).

The light emerging from the receptacles (154,156,158,160) that is due at least in part from the light from the semiconductor lasers (136,138,140,142) impinging upon the target material contained in the receptacles (154,156,158,160) is received by the detectors (146,148,150,152) and analyzed with any number of techniques, which are generally particular to the target material and the light interaction utilized for analyzing the target material. For example, light interactions that are suitable for analyzing target materials include, but is not limited to, fluorescence and phosphorescence, light scattering, light absorption, light reflection or the like. The light as a result of at least the interaction between the light emitted from one of the semiconductor lasers and a target material is detected by at least one of the detectors (146,148,150,152).

In light interactions that result in light of a wavelength that is not the wavelength originally emitted by the semiconductor laser, spectral filtering can be optionally provided with a filter 186, which can have one or more filters to exclude the excitation radiation emitted by the semiconductor lasers (136,138,140,142). An example of a suitable filter 186 is a dielectric coating filter. In light interactions that involve absorption, the detectors (146,148,150,152) will detect a decrease in light transmission. In detecting light interactions involving light scattering, the detectors (146,148,150,152) are preferably positioned such that the direct path of excitation light does not pass through the detectors (146,148,150,152). In this way, the excitation light will not be likely to produce false signals. Optionally, an optical collecting and imaging system (e.g., lenses) 188 can be used to collimate the light from the light interaction through the filter 186 to impinge upon the detectors (146,148,150,152), thereby enhancing the optical signals.

The detectors (146,148,150,152) can be any suitable photodetector such as a photodiode. The detectors (146,148,150,152) are generally configured to convert light emerging from the target materials contained in the receptacles into an electrical signal. For example, the detectors (146,148,150,152) can be configured to produce electrical signals in response to particular light wavelengths that are emitted by the fluorescent material.

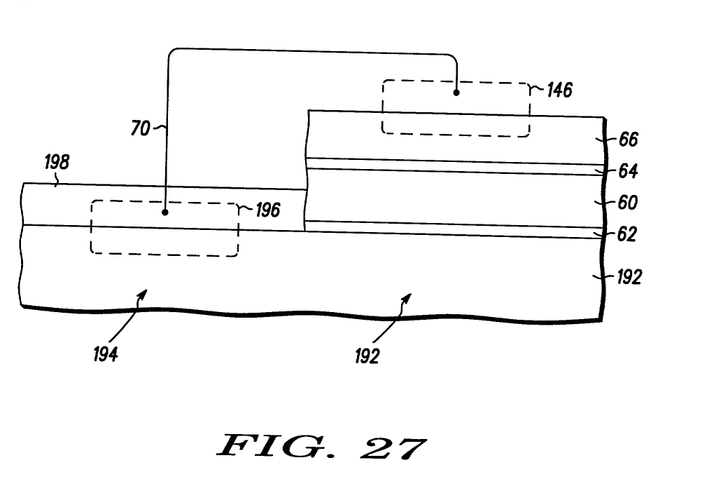

Referring to FIG. 27, a portion of the semiconductor structure 144 of FIG. 24 having the detectors (146,148,150,152) is illustrated schematically, in cross section, in accordance with an embodiment of the present invention. The semiconductor structure 144 includes a monocrystalline semiconductor substrate 190, preferably a monocrystalline silicon wafer. The monocrystalline semiconductor substrate 190 includes a first region 192 and a second region 194. An electrical semiconductor component 196 generally indicated by the dashed line is formed, at least partially, in the second region 194. The electrical semiconductor component 196 can be a resistor, a capacitor, an active semiconductor component such as a diode or a transistor or an integrated circuit such as a CMOS integrated circuit. For example, the electrical semiconductor component 196 can be a CMOS integrated circuit configured to perform digital signal processing or another function for which silicon integrated circuits are well suited. Conventional semiconductor processing as well known and widely practiced in the semiconductor industry can form the electrical semiconductor component 196. A layer of insulating material 198 such as a layer of silicon dioxide or the like may overlie electrical semiconductor component 196.

The insulating material 198 and any other layers that may have been formed or deposited during the processing of electrical semiconductor component 196 are removed from the surface of the first region 192 to provide a bare silicon surface in that region. As is well known, bare silicon surfaces are highly reactive and a native silicon oxide layer can quickly form on the bare surface. A layer of barium or barium and oxygen is deposited onto the native oxide layer on the surface of the first region 192 and is reacted with the oxidized surface to form a first template layer (not shown). In accordance with one embodiment, a monocrystalline oxide layer is formed overlying the template layer by a process of molecular beam epitaxy. Reactants including barium, titanium and oxygen are deposited onto the template layer to form the monocrystalline oxide layer. Initially during the deposition, the partial pressure of oxygen is kept near the minimum necessary to fully react with the barium and titanium to form monocrystalline barium titanate layer. The partial pressure of oxygen is then increased to provide an overpressure of oxygen and to allow oxygen to diffuse through the growing monocrystalline oxide layer. The oxygen diffusing through the barium titanate reacts with silicon at the surface of the first region 192 to form an amorphous layer of silicon oxide on second region 194 and at the interface between silicon substrate 192 and the monocrystalline oxide. Layers 60 and 62 may be subject to an annealing process as described above in connection with FIG. 3 to form a single amorphous accommodating layer.

In accordance with an embodiment, the step of depositing the monocrystalline oxide layer is terminated by depositing a second template layer 60, which can be 1-10 monolayers of titanium, barium, barium and oxygen, or titanium and oxygen. A layer 66 of a monocrystalline compound semiconductor material is then deposited overlying second template layer 64 by a process of molecular beam epitaxy. The deposition of layer 66 is initiated by depositing a layer of arsenic onto template 64. This initial step is followed by depositing gallium and arsenic to form monocrystalline gallium arsenide 66. Alternatively, strontium can be substituted for barium in the above example.

The first photodetector 146, generally indicated by a dashed line 200 is formed in compound semiconductor layer 66. Semiconductor component 68 can be formed by processing steps conventionally used in the fabrication of gallium arsenide or other IIIV compound semiconductor material devices. A metallic conductor schematically indicated by the line 70 can be formed to electrically couple the electrical semiconductor component 196 and the first photodetector 146, thus implementing an integrated device that includes at least one component formed in the monocrystalline silicon substrate 190 and one device formed in monocrystalline compound semiconductor material layer 66. Although the semiconductor structure 144 has been described as a structure formed on a monocrystalline silicon substrate 190 having a barium (or strontium) titanate layer 60 and a gallium arsenide layer 66, similar devices can be fabricated using other substrates, monocrystalline oxide layers and other compound semiconductor layers as described elsewhere in this disclosure. As can be appreciated by one of ordinary skill in the art, the semiconductor structure 144 can receive radiation emissions from target materials contained in at least two of the receptacles that are produced at least in part with the reception of the radiation with the first wavelength and second wavelength.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential features or elements of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. An apparatus for analyzing target materials, comprising:
a monocrystalline silicon substrate;
an amorphous oxide material overlying the monocrystalline silicon substrate;
a monocrystalline perovskite oxide material overlying the amorphous oxide material; and
a plurality of semiconductor lasers formed of a monocrystalline compound semiconductor material overlying the monocrystalline perovskite oxide material, at least a first semiconductor laser of said plurality of semiconductor lasers configured to emit radiation with a first wavelength and at least a second semiconductor laser of said plurality of semiconductor lasers configured to emit radiation with a second wavelength other than said first wavelength; and
a plurality of receptacles associated with said plurality of semiconductor lasers, said plurality of receptacles configured to receive the target materials and at least a first receptacle of said plurality of receptacles configured to receive radiation with said first wavelength emitted from said first semiconductor laser and at least a second receptacle of said plurality of receptacles configured to receive radiation with said second wavelength emitted from said second semiconductor laser.

2. The apparatus for analyzing the target materials of claim 1, further comprising:
a second monocrystalline silicon substrate;
a second amorphous oxide material overlying the monocrystalline silicon substrate;
a second monocrystalline perovskite oxide material overlying the second amorphous oxide material; and
a plurality of detectors formed of a second monocrystalline compound semiconductor material overlying the second monocrystalline perovskite oxide material, said plurality of detectors configured to receive emissions from the target materials contained in at least two receptacles of said plurality of receptacles that is produced at least in part with the reception of radiation with the first wavelength and the second wavelength.

3. The apparatus for analyzing the target materials of claim 1, wherein said plurality of semiconductor lasers is vertical cavity surface emitting lasers (VCSELS).

4. The apparatus for analyzing the target materials of claim 1, further comprising a detector configured to detect emissions from the target materials contained in at least one of said plurality of receptacles.

5. The apparatus for analyzing the target materials of claim 1, wherein said first receptacle of said plurality of receptacles is configured to receive a first target material of the target materials and said second receptacle of said plurality of receptacles is configured to receive a second target material of the target materials other than said first target material.

6. The apparatus for analyzing the target materials of claim 1, wherein a third semiconductor laser of said plurality of semiconductor lasers emits radiation with a third wavelength other than said first wavelength and said second wavelength.

7. The apparatus for analyzing the target materials of claim 1, wherein a fourth semiconductor laser of said plurality of semiconductor lasers emits radiation with a fourth wavelength other than said first wavelength, said second wavelength and said third wavelength.

8. The apparatus for analyzing the target materials of claim 1, wherein said first receptacle of said plurality of receptacles is configured to receive a first target material of the target materials and said second receptacle of said plurality of receptors is configured to receive said first target material of the target materials.

9. The apparatus for analyzing the target materials of claim 1, wherein said first receptacle of said plurality of receptacles is configured to receive a first target material of the target materials and said second receptacle of said plurality of receptors is configured to receive a second target material of the target materials other than said first target material.

10. The apparatus for analyzing the target materials of claim 1, wherein at least one of said plurality of receptacles is a cavity formed in an assay support structure.

11. The apparatus for analyzing the target materials of claim 1, wherein at least one of said plurality of receptacles is a target pad.

12. The apparatus for analyzing the target materials of claim 11, wherein said target pad includes a material that is configured to react with the target materials.

13. The apparatus for analyzing the target materials of claim 12, wherein said material that is configured to react with the target materials is a DNA oligos.

14. The apparatus for analyzing the target materials of claim 1, wherein at least one of said plurality of receptacles includes a fluorescent tag.

15. The apparatus for analyzing the target materials of claim 1, wherein radiation is emitted from said first receptacle due at least in part from a light interaction between said radiation with said first wavelength.

16. The apparatus for analyzing the target materials of claim 15, wherein said light interaction is fluorescence.

17. The apparatus for analyzing the target materials of claim 15, wherein said light interaction is phosphorescence.

18. The apparatus for analyzing the target materials of claim 15, wherein said light interaction is light scattering.

19. The apparatus for analyzing the target materials of claim 15, wherein said light interaction is light absorption.

20. The apparatus for analyzing the target materials of claim 15, wherein said light interaction is light reflection.

21. The apparatus for analyzing the target materials of claim 1, further comprising a filter that is configured to exclude radiation of said first wavelength that is emitted by said first semiconductor laser of said plurality of semiconductor lasers.

22. The apparatus for analyzing the target materials of claim 2, wherein at least one of said plurality of detectors is a photodiode.

23. A process for fabricating an apparatus for analyzing target materials, comprising:
providing a monocrystalline silicon substrate;
depositing a monocrystalline perovskite oxide film overlying the monocrystalline silicon substrate, the monocrystalline perovskite oxide film having a thickness less than a thickness of the material that would result in strain-induced defects;
forming an amorphous oxide interface layer containing at least silicon and oxygen at an interface between the monocrystalline perovskite oxide film and the monocrystalline silicon substrate;
epitaxially forming a monocrystalline compound semiconductor layer overlying the monocrystalline perovskite oxide film;
forming a plurality of semiconductor lasers at least partially from said monocrystalline compound semiconductor layer, at least a first semiconductor laser of said plurality of semiconductor lasers configured to emit radiation with a first wavelength and at least a second semiconductor laser of said plurality of semiconductor lasers configured to emit radiation with a second wavelength other than said first wavelength; and
forming a plurality of receptacles to contain the target materials, at least a first receptacle of said plurality of receptacles configured to receive said radiation with said first wavelength emitted from said first semiconductor laser and at least a second receptacle of said plurality of receptacles configured to receive said radiation with said second wavelength emitted from said second semiconductor laser.

24. The process for fabricating an apparatus for analyzing target materials of claim 23, further comprising:
providing a second monocrystalline silicon substrate;
depositing a second monocrystalline perovskite oxide film overlying the second monocrystalline silicon substrate, the second monocrystalline perovskite oxide film having a second thickness less than a second thickness of the material that would result in strain-induced defects;
forming a second amorphous oxide interface layer containing at least silicon and oxygen at an interface between the second monocrystalline perovskite oxide film and the second monocrystalline silicon substrate;
epitaxially forming a second monocrystalline compound semiconductor layer overlying the second monocrystalline perovskite oxide film; and
forming a plurality of detectors at least partially from said second monocrystalline compound semiconductor material overlying said second monocrystalline perovskite oxide material, said plurality of detectors configured to receive emissions from the target materials contained in at least two receptacles of said plurality of receptacles that is produced at least in part with the reception of radiation with the first wavelength and the second wavelength.

25. The process for fabricating an apparatus for analyzing target materials of claim 23, wherein said plurality of semiconductor lasers is vertical cavity surface emitting lasers (VCSELS).

26. The process for fabricating an apparatus for analyzing target materials of claim 23, further comprising configuring a detector to detect emissions from the target materials contained in at least one of said plurality of receptacles.

27. The process for fabricating an apparatus for analyzing target materials of claim 23, further comprising:
configuring said first receptacle of said plurality of receptacles to receive a first target material of the target materials; and
configuring said second receptacle of said plurality of receptacles to receive a second target material of the target materials other than said first target material.

28. The process for fabricating an apparatus for analyzing target materials of claim 23, wherein said forming said plurality of semiconductor lasers at least partially from said monocrystalline compound semiconductor layer includes forming a third semiconductor laser that is configured to emit radiation with a third wavelength other than said first wavelength and said second wavelength.

29. The process for fabricating an apparatus for analyzing target materials of claim 28, wherein said forming said plurality of semiconductor lasers at least partially from said monocrystalline compound semiconductor layer includes forming a fourth semiconductor laser of said plurality of semiconductor lasers that is configured to emit radiation with a fourth wavelength other than said first wavelength, said second wavelength and said third wavelength.

30. The process for fabricating an apparatus for analyzing target materials of claim 23, wherein forming said plurality of receptacles includes forming said first receptacle of said plurality of receptacles to receive a first target material of the target materials and forming said second receptacle of said plurality of receptors to receive said first target material of the target materials.

31. The process for fabricating an apparatus for analyzing target materials of claim 23, wherein forming said plurality of receptacles includes forming said first receptacle of said plurality of receptacles to receive a first target material of the target materials and forming said second receptacle of said plurality of receptors to receive a second target material of the target materials other than said first target material.

32. The process for fabricating an apparatus for analyzing target materials of claim 23, wherein at least one of said plurality of receptacles is a cavity formed in an assay support structure.

33. The process for fabricating an apparatus for analyzing target materials of claim 23, wherein at least one of said plurality of receptacles is a target pad.

34. The process for fabricating an apparatus for analyzing target materials of claim 33, wherein said target pad includes a material that is configured to react with the target materials.

35. The process for fabricating an apparatus for analyzing target materials of claim 34, wherein said material that is configured to react with the target materials is a DNA oligos.

36. The process for fabricating an apparatus for analyzing target materials of claim 23, wherein at least one of said plurality of receptacles includes a fluorescent tag.

37. The process for fabricating an apparatus for analyzing target materials of claim 24, wherein at least one of said plurality of detectors is a photodiode.

38. An apparatus for analyzing target materials, comprising:
a first semiconductor structure having a plurality of semiconductor lasers, said plurality of semiconductor lasers having at least a first semiconductor laser configured to emit radiation with a first wavelength and at least a second semiconductor laser configured to emit radiation with a second wavelength other than said first wavelength, said first semiconductor structure comprising:
a monocrystalline silicon substrate;
an amorphous oxide material overlying the monocrystalline silicon substrate;
a monocrystalline perovskite oxide material overlying the amorphous oxide material; and
a monocrystalline compound semiconductor material overlying the monocrystalline perovskite oxide material, said monocrystalline compound semiconductor material at least partially forming said plurality of semiconductor lasers;
a second semiconductor structure having a plurality of detectors, said plurality of detectors having at least a first receptacle associated with said first semiconductor laser and a second receptacle associated with the second semiconductor laser, said second semiconductor structure comprising:
a second monocrystalline silicon substrate;
a second amorphous oxide material overlying the monocrystalline silicon substrate;
a second monocrystalline perovskite oxide material overlying the second amorphous oxide material; and
a second monocrystalline compound semiconductor material overlying the second monocrystalline perovskite oxide material, said second monocrystalline perovskite oxide material at least partially forming said plurality of detectors; and
a plurality of receptacles interposed between said first semiconductor structure and said second semiconductor structure, said plurality of receptacles configured to receive the target materials and at least a first receptacle of said plurality of receptacles configured to receive radiation with said first wavelength emitted from said first semiconductor laser and at least a second receptacle of said plurality of receptacles configured to receive radiation with said second wavelength emitted from said second semiconductor laser.
